(19) United States
(12) Patent Application Publication
(10) Pub. No.: US 2021/0337750 A1
(43) Pub. Date: Nov. 4, 2021

(54) BLOCK STORAGE ELEMENT WITH FLUID TRANSFER AND OVERFLOW MECHANISM

(71) Applicant: Jungheinrich Aktiengesellschaft, Hamburg (DE)

(72) Inventors: Volker ROLLWA, Pirmasens (DE); Jörg CAVELIUS, Bad Vilbel (DE); Markus LIEBHABER, Oberursel (DE)

(73) Assignee: Jungheinrich Aktiengesellschaft, Hamburg (DE)

(21) Appl. No.: 17/306,590

(22) Filed: May 3, 2021

(30) Foreign Application Priority Data
May 4, 2020 (EP) 20172794.8

(51) Int. Cl. A01G 31/06; A01G 18/69

(52) U.S. Cl. CPC A01G 31/06; A01G 2031/006; A01G 18/69

(57) ABSTRACT

A block storage element which is used for the propagation of vegetable or fungal biomass and is stackable. To enhance functionality of the block storage element, the block storage element includes a fluid reservoir with an overflow mechanism.

### CROSS-REFERENCE TO RELATED APPLICATIONS

The present application claims priority under 35 U.S.C. § 119 of European Patent Application No. 20172794.8, filed May 4, 2020, the disclosure of which is expressly incorporated by reference herein in its entirety.

### BACKGROUND OF THE INVENTION

### 1. Field of the Invention

Embodiments relate to a block storage element which is used for the propagation of vegetable or fungal biomass and is stackable.

Embodiments furthermore relate to a block storage arrangement having a block storage element receiving space in which at least one block storage element is arranged.

Embodiments additionally relate to a method for removing a block storage element.

### 2. Discussion of Background Information

Known block storage elements are merely used for the placement into storage, storage, and removal from storage of objects being stored in a block storage system. Aside from a pure storage function, the block storage system and the block storage element have no other purposes.

A block storage system or a block storage arrangement denotes a storage arrangement having at least one block storage element receiving space. Stackable block storage elements can be placed into and removed from storage in the block storage element receiving space. For this purpose, at least one block storage element is placed into or removed from storage in the block storage element receiving space through a loading space. The loading space can be arranged above or below the block storage element receiving space in the direction of gravity, so that a placement-into-storage direction or removal-from-storage direction is oriented in the direction of gravity or against the direction of gravity. The placement-into-storage and removal-from-storage direction is determined by the arrangement of the loading space. If the loading space is arranged above the block storage element receiving space, the placement-into-storage direction is in the direction of gravity and the removal-from-storage direction is against the direction of gravity. If the loading space is arranged below the block storage element receiving space in the direction of gravity, the placement-into-storage direction is oriented against the direction of gravity and the removal-from-storage direction is oriented in the direction of gravity. If multiple block storage elements are placed into storage in the block storage element receiving space, a block storage element stack is formed. Other terms for the block storage system are stacking storage system or container stacking storage system. In the present exemplary embodiment, the block storage element receiving space is arranged above the loading space in the direction of gravity.

### SUMMARY OF THE INVENTION

Embodiments enhance the functionality of a block storage element.

In particular, embodiments are directed to a block storage element which is used for the propagation of vegetable or fungal biomass and is stackable. The block storage element comprises a fluid reservoir with an overflow mechanism.

The block storage element of the type named at the outset includes a fluid reservoir with an overflow mechanism. With this arrangement, the block storage element can be used for the propagation of vegetable or fungal biomass or the cultivation thereof. With the fluid reservoir, plants in different stages, such as seeds, seedlings, or the like, or also fungi can be supplied with fluid. Through the arrangement of the plants or fungi at the fluid reservoir, the plants or fungi are supplied with fluid and/or nutrient solution. Plants can be arranged above the fluid reservoir and extend into the fluid reservoir with their roots. The plants can thus draw fluid out of the fluid reservoir via their roots. For this purpose, plants or fungi can be arranged in containers which comprise a fluid-permeable base. Roots of the plants can also become entangled in the base. In addition, excess fluid from the fluid reservoir can be conducted away through the overflow mechanism. In this manner, no waterlogging can occur which could damage plants and/or fungi located in the fluid reservoir. The plants and/or fungi thus encounter optimal growth conditions. In addition to a reduction of waterlogging, a block storage element located thereunder can be supplied with a fluid and/or nutrient solution through the overflow mechanism of the block storage element. A block storage element stack thus requires only one fluid and/or nutrient solution feed, which results in fewer costs. With this arrangement, the block storage element can be placed into storage in a block storage system and used for the propagation of biomass. The functionality of the block storage element is enhanced. Furthermore, with an arrangement of this type, a plurality of plants and/or fungi can grow in a relatively small space.

Preferably, the overflow mechanism interacts with a channeling or distribution apparatus. Fluid and/or nutrient solution conducted away through the overflow mechanism is prevented by the channeling or distribution apparatus from directly re-entering the overflow mechanism in the block storage element located thereunder. The fluid and/or nutrient solution conducted away in such a manner thus supplies the block storage element located thereunder in an optimal manner. The block storage element can thereby comprise a tray, wherein the tray can comprise a channeling structure which channels the fluid and/or nutrient solution. The channeling structure can ensure that the fluid and/or nutrient solution can be evenly distributed in the tray before the fluid and/or nutrient solution can enter into the next block storage element through the overflow mechanism. The channeling or distribution apparatus can for example comprise a groove, similar to a rain gutter.

Preferably, the block storage element comprises an outlet valve. Using the outlet valve, the fluid and/or nutrient solution can be drained in a removal-from-storage process. In this manner, the risk of a spillover during the removal-from-storage process can be prevented, as a result of which the block storage element is easier to handle. Furthermore, the outlet valve can conduct away excess fluid and/or nutrient solution that is introduced into the block storage element during a watering process. The collected fluid and/or nutrient solution can be processed and reused.

Preferably, the block storage element comprises an inlet funnel. Through the inlet funnel, fluid and/or nutrient solution channeled by the channeling or distribution apparatus is collected and fed to the fluid reservoir in a targeted manner. Potential flow-related erosions and flushing of substrate material can thereby be prevented. With the inlet funnel, the fluid and/or nutrient solution can furthermore be distributed in a targeted manner to supply all of the plants or fungi arranged in the block storage element with the fluid and/or nutrient solution in an optimal manner.

Preferably, the inlet funnel and the overflow mechanism are arranged in different regions of the block storage element. Fluid and/or nutrient solution that drains off via the overflow mechanism is channeled by the channeling or distribution apparatus to the inlet funnel of the block storage element located thereunder. Because the inlet funnel and the overflow mechanism are arranged in different regions of the block storage element, the fluid and/or nutrient solution must travel a certain distance before the fluid and/or nutrient solution reaches the overflow mechanism again. A supply of the fluid and/or nutrient solution to the entire fluid reservoir is thereby enabled, so that all plants and/or fungi that are arranged in the fluid reservoir are supplied.

Furthermore, embodiments are directed to a block storage arrangement having a block storage element receiving space in which at least one block storage element is arranged comprises at least one fluid and/or nutrient supply device. With this arrangement, the block storage element can be supplied with fluid and or nutrient solution. The fluid and/or nutrient solution supply device performs the supply of the plants and/or fungi so that human work is no longer required. As a result, running costs are reduced and a constant supply of fluid and/or nutrients is ensured.

Preferably, the fluid and/or nutrient supply device comprises at least one shutoff valve. Using this shutoff valve, a feed to the fluid reservoir of the block storage element can be controlled. The fluid and/or nutrient solution can be fed as needed. An oversupply or undersupply can thus be avoided. Furthermore, optimal conditions can be created for each type of plant and/or fungus so that the plants and/or fungi encounter optimal growing conditions.

Preferably, the fluid and/or nutrient solution supply device comprises an actuating apparatus for the outlet valve. The outlet valve on the block storage element is actuated using this actuating apparatus, whereby fluid and/or nutrient solution that is to be conducted away can be drained. With this actuating apparatus, the outlet valve can be kept relatively simple, since it can be actuated in a purely mechanical manner.

Preferably, the fluid and/or nutrient solution supply device comprises a storage tank. The storage tank can be arranged above, in the direction of gravity, or in an upper region of the block storage element receiving space, whereby the fluid and/or nutrient solution can be transferred with the assistance of gravity into a fluid reservoir arranged below.

Preferably, the fluid and/or nutrient solution supply device comprises a pump. The pump can pump the fluid and/or nutrient solution through the fluid and/or nutrient supply device. There is thus no dependency on the effect of gravity, and the fluid and/or nutrient solution can also be conveyed against gravity. For example, starting with the actuation, collected fluid and/or nutrient solution can transfer into the storage tank through the pump.

Preferably, at least two elements of the fluid and/or nutrient solution supply device are in fluid connection. Thus, the actuating apparatus can be in fluid connection with the pump, for example, and the pump can also be in fluid connection with the storage tank. As a result, excess fluid and/or nutrient solution can be transferred back into the storage tank. The storage tank can also be in fluid connection with the shutoff valve. The fluid and/or nutrient solution can thus be conveyed over the fluid connection. With the fluid connection, a simple transfer of the fluid and/or nutrient solution is possible.

Embodiments are directed to a method of the type named at the outset, in which a block storage element, which includes a fluid reservoir that is maximally filled with fluid up to the overflow mechanism, is drained before a removal. In this manner, a block storage element is removed from storage with a relatively empty fluid reservoir so that the weight of the block storage element is reduced. In addition to a lower risk of sloshing, this enables easy handling of the block storage element.

Preferably, the block storage elements can be drained and removed sequentially. Through the sequential draining and removal of the block storage elements, a block storage element stack can be drained using only one actuating apparatus. This reduces the costs, both production costs and also maintenance costs. The block storage system comprises only one actuating apparatus per block storage element receiving space. The peripheral equipment, such as the storage tank, processing, pump, or the like, can interact with one or more block storage element receiving spaces. This keeps a design of the block storage system simple.

Preferably, the bottommost block storage element of block storage elements being removed from a stack is drained and removed in each case. With the removal of the bottommost block storage element, gravity is used to remove the fluid and/or nutrient solution. A pure flowing motion of the fluid is thereby rendered possible, and pump operations are no longer required.

Preferably, the shutoff valve and outlet valve interact for the draining. The shutoff valve and outlet valve interact so that no new fluid and/or nutrient solution is resupplied during a draining procedure. The time of the draining procedure is thus reduced, which likewise reduces the removal times.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a block storage arrangement;

FIG. 2 shows a block storage element;

FIG. 3 shows a side view of the block storage element;

FIG. 4 shows a cross-section of an outlet valve and an actuating apparatus in a non-actuated state;

FIG. 5 shows a cross-section of an outlet valve and an actuating apparatus in an actuated state; and

FIG. 6 shows a flow diagram of the block storage arrangement.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

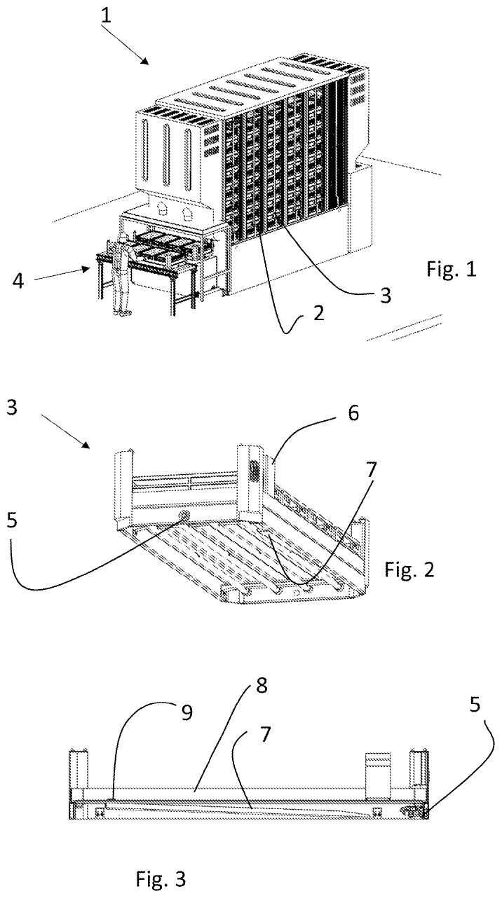

The block storage arrangement 1 illustrated in FIG. 1 comprises at least one block storage element receiving space 2. A loading space, not shown, is arranged below the block storage element receiving space 2. At least one block storage element 3 is arranged in the block storage element receiving space 2. The block storage element 3 can be transferred into an interior of the block storage system through a placement-into-storage and removal-from-storage station 4.

FIG. 2 shows an illustration of the block storage element 3. An outlet valve 5 is arranged on a front face of the block storage element 3. An inlet funnel 6 is arranged on the top side of the block storage element 3. The bottom side of the block storage element 3 comprises a channeling or distribution apparatus 7.

FIG. 3 illustrates a side view of the block storage element 3. A fluid reservoir 8 is arranged in a base of the block storage element 3. In the base, an overflow mechanism 9 is also arranged which interacts with the channeling or distribution apparatus 7.

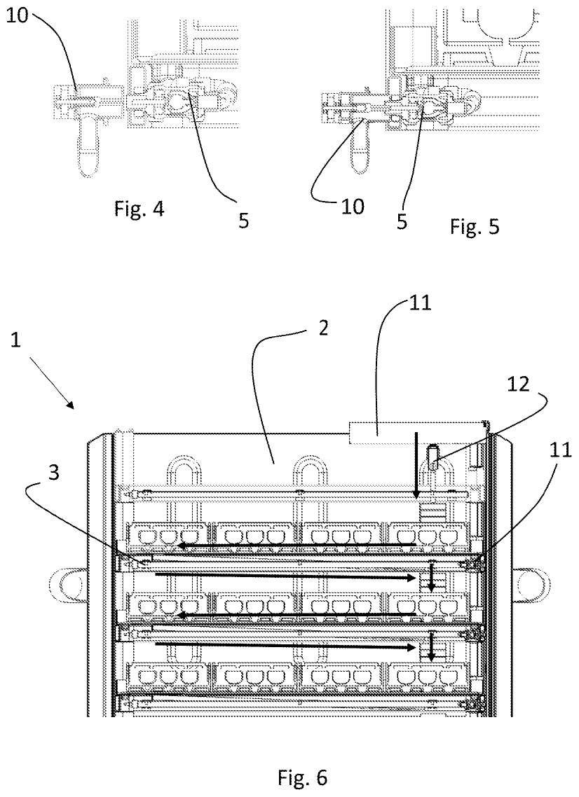

In FIGS. 4 and 5, a cross-section of the actuating apparatus 10 and of the outlet valve 5 is illustrated. FIG. 4 thereby shows a non-actuated state in which the actuating apparatus 10 and the outlet valve 5 are separated. The actuating apparatus 10 is furthermore arranged outside of the block storage element receiving space 2 in the non-actuated state. The outlet valve 5 is actuated by the actuating apparatus 10.

In FIG. 5, an actuated state is illustrated in which the actuating apparatus 10 actuates the outlet valve 5. The outlet valve 5 is in fluid connection with the fluid reservoir 8. The actuating apparatus 10 is moved from the non-actuated state into the actuated state and vice versa by a movement mechanism which is not shown.

FIG. 6 shows a flow diagram for the block storage arrangement 1 having multiple block storage elements 3 that are arranged in a block storage element receiving space 2. The arrows illustrated schematically show a flow of fluid and/or nutrient solution. This exemplary illustration furthermore shows a storage tank 11 which can be arranged at a topmost point, in the direction of gravity, of a fluid and/or nutrient supply device. The storage tank 11 is in fluid connection with a shutoff valve 12. In this example, planting containers are arranged in the fluid reservoir 8, in which planting containers plants are also arranged. The planting containers comprise a fluid-permeable base in which plant roots can become entangled. The plants are stabilized by their roots and the base of the planting container. The plants can also grow on a substrate or the like. The block storage element 3 comprises an overflow mechanism 9 that interacts with the channeling or distribution apparatus 7. The overflow mechanism 9 is arranged at a first end of the channeling or distribution apparatus 7, and the inlet funnel 6 is arranged at a second end of the channeling or distribution apparatus 7. The fluid reservoir 8 furthermore comprises a channeling structure which channels the fluid and/or nutrient solution to the overflow mechanism 9 starting from the inlet funnel 6. The channeling structure thereby ensures that the fluid and/or nutrient solution reaches a majority of the fluid reservoir 8 before the fluid and/or nutrient solution arrives at the overflow mechanism 9. The block storage element 3 furthermore comprises an outlet valve 5. Starting from the bottommost block storage element 3, the fluid and/or nutrient solution is transferred, for example, into a processing device, not shown, or the storage tank 11 by a pump not shown.

An exemplary process will be described below, starting with a placement of the block storage element 3 into storage and continuing through growth phases of plants which are arranged in a planting container in the fluid reservoir 8, up to the removal of the block storage element 3 from storage together with the plants arranged in the planting container.

The block storage element 3 is loaded with seeds, seedlings, or plants and is transferred into the placement-into-storage and removal-from-storage station 4. The placement-into-storage and removal-from-storage station 4 forms an entrance to and exit from the block storage arrangement 1. The placement-into-storage and removal-from-storage station 4 can thereby be connected to the loading space by a port arrangement not shown. The block storage element 3 is transferred into the block storage element receiving space 2 via the loading space.

The block storage element 3 is transferred into the block storage system 1 through a placement-into-storage and removal-from-storage station 4, and is also removed again therefrom. In the present embodiment, the placement-into-storage and removal-from-storage station 4 is connected to the loading space by a port not shown. The port is in turn connected to the loading space, which is arranged below at least one block storage element receiving space 2. In the loading space, a movable loading vehicle is arranged which transfers the block storage element 3 from the port into a block storage element receiving space 2. To do so, the loading vehicle picks up the block storage element 3 from the port in that the loading vehicle lifts up the block storage element 3 from below, in the direction of gravity, as a result of which the block storage element 3 is arranged on the loading vehicle. The loading vehicle, together with the block storage element 3, then moves to the block storage element receiving space 2 into which the block storage element 3 is to be placed into storage. Upon arriving there, the loading vehicle lifts the block storage element 3 upwards against the direction of gravity. If one or more block storage elements 3 are already arranged in the block storage element receiving space 2 that is to be filled, the loading vehicle lifts the block storage element 3 being placed into storage, together with the block storage elements 3 arranged up above, and thus forms a block storage element stack. Once the block storage element stack has been lifted above a certain height by the loading vehicle, holding elements, not shown, that hold the block storage element stack move so that the loading vehicle can lower again without the block storage element 3. The loading vehicle is then free and can place additional block storage elements 3 into storage or remove them from storage. During a removal-from-storage process, only the bottommost block storage element 3 of a block storage element stack arranged in a block storage element receiving space 2 can be removed in each case. For this purpose, the loading vehicle is positioned below the block storage element 3 being removed and lifts it or the block storage element stack so that the holding element moves into a release position. The loading vehicle then lowers the block storage element stack. Once the block storage element stack has been lowered a certain distance, the holding elements move back into a holding position and hold the remaining block storage element stack in the block storage element receiving space 2. The bottommost block storage element 3 of the block storage element stack is then arranged on the loading vehicle, which transfers the block storage element 3 to the port arrangement (port). From there, the block storage element 3 can be transported further, serviced, repaired, placed back into storage, or the like. The procedure of placing the block storage element 3 into storage is repeated until a desired number of block storage elements 3 is arranged in the block storage element receiving space 2.

Once the desired number of block storage elements 3 is then arranged in the block storage element receiving space 2, the fluid and/or nutrient supply device can supply the block storage elements 3 with fluid and/or nutrient solutions (hereinafter referred to as fluid). For this purpose, fluid is transferred into the fluid reservoir 8 of a first block storage element 3 via the shutoff valve 12 starting from the storage tank 11. In this exemplary embodiment, the first block storage element 3 is the uppermost block storage element 3 of a block storage element stack. A fluid level in the fluid reservoir 8 rises until the fluid flows over the overflow mechanism 9. From the overflow mechanism 9, the fluid flows via the channeling or distribution apparatus 7 into the inlet funnel 6 of the second block storage element 3 located thereunder. The channeling or distribution apparatus 7 can thereby comprise a groove, a hose, a tube, or the like. The procedure is then repeated until all fluid reservoirs 8 of the block storage elements 3 within the block storage element receiving space 2 have been supplied with adequate fluid. A fluid flow through the fluid reservoir 8 occurs because the overflow mechanism 9 and the inlet funnel 6 are arranged at a distance from one another. The fluid thus floods the entire fluid reservoir 8 before the fluid can run off through the overflow mechanism 9. Preferably, the overflow mechanism 9 and the inlet funnel 6 are arranged at different ends of the fluid reservoir 8.

Because no other block storage element 3 is arranged below the bottommost block storage element 3, the channeling or distribution apparatus 7 would no longer work properly. The outlet valve 5 of the bottommost block storage element 3 therefore interacts at least temporarily with the actuating apparatus 10. It is thus prevented that the fluid drains out via the overflow mechanism 9 of the bottommost block storage element 3.

Through the interaction of the outlet valve 5 and the actuating apparatus 10, the fluid level is lowered early enough before an overflow of the fluid in the fluid reservoir 8 of the bottommost block storage element 3. The collected fluid is fed to a processing device not shown, and is from there transferred back into the storage tank 11 or other components. Starting from the actuating apparatus 10, the fluid is conveyed by a pump not shown. However, the pump can thereby also be arranged at a different location, for example downstream of the processing or in the region of the storage tank 11. As soon as the fluid level has risen sufficiently in every fluid reservoir 8 of the block storage elements 3, the shutoff valve 12 is closed again. As a result, no additional fluid can reach the block storage elements 3 or the fluid reservoir 8. At chronological intervals, the shutoff valve 12 can be opened again in order to restore the fluid level that was depleted by the plants or fungi. The outlet valve 5 can also be opened by the actuating apparatus 10 once the fluid has reached a certain height in the fluid reservoir 8. An unintended runoff through the overflow mechanism 9 can thus be prevented. A continuous, consistent circulation of the fluid and/or nutrient supply device is likewise possible, but not always necessary.

To remove the block storage elements 3 from storage together with the plants that are ready for harvesting, the fluid is fully or partially emptied in the respective bottommost block storage element 3 by an interaction of the outlet valve 5 and the actuating apparatus 10. As a result, the block storage element 3 can be handled more easily, since on the one hand the block storage element 3 weighs less and on the other hand the risk of a fluid spilling over is reduced. The block storage element 3 can be removed from storage in its drained state. For this purpose, the block storage element 3, as described above, is removed in a downward direction and delivered to the placement-into-storage and removal-from-storage station 4 through the port. From there, the block storage element 3 can be processed or transported further. In addition, in a state of having been removed from storage, the block storage element 3 can be serviced in that the outlet valve 5 is replaced or changed.

Depending on whether the plants are to be harvested, transplanted, or transported, a certain level of fluid can remain in the fluid reservoir 8. The plants thus remain in contact with the fluid during transport, as a result of which they are longer-lasting.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE NUMERALS

1 Block storage arrangement
2 Block storage element receiving space
3 Block storage element
4 Placement-into-storage and removal-from-storage station
5 Outlet valve
6 Inlet funnel
7 Channeling or distribution apparatus
8 Fluid reservoir
9 Overflow mechanism
10 Actuating apparatus
11 Storage tank
12 Shutoff valve

What is claimed:

1. A block storage element for propagation of vegetable or fungal biomass, comprising:
a fluid reservoir with an overflow mechanism,
wherein the block storage element is configured to be stackable.

2. The block storage element according to claim 1, further comprising a channeling or distribution apparatus, wherein the overflow mechanism interacts with the channeling or distribution apparatus.

3. The block storage element according to claim 1, further comprising an outlet valve.

4. The block storage element according to claim 1, further comprising an inlet funnel.

5. The block storage element according to claim 4, wherein the inlet funnel and the overflow mechanism are arranged in different regions of the block storage element.

6. A block storage arrangement comprising:
a block storage element receiving space configured to receive at least one block storage element according to claim 1; and
at least one fluid or nutrient supply device.

7. The block storage arrangement according to claim 6, wherein the at least one fluid or nutrient supply device comprises at least one shutoff valve.

8. The block storage arrangement according to claim 6, wherein the at least one fluid or nutrient supply device comprises an actuating apparatus for an outlet valve of the at least one block storage element.

9. The block storage arrangement according to claim 6, wherein the at least one fluid or nutrient supply device comprises a pump.

10. The block storage arrangement according to claim 6, wherein the at least one fluid or nutrient supply device comprises a storage tank.

11. The block storage arrangement according to claim 6, wherein at least two elements of the at least one fluid or nutrient supply device are at least in fluid connection.

12. A method for removing the block storage element according to claim 1 from a block storage arrangement, wherein the fluid reservoir is maximally filled with fluid up to an overflow mechanism, the method comprising:
draining the fluid reservoir of the block storage element.

13. The method according to claim 12, wherein the block storage arrangement comprises a plurality of block storage elements that are drained and removed sequentially.

14. The method according to claim 12, wherein the plurality of block storage elements are stacked, and the method further comprises a bottommost block storage element of the stacked block storage elements is drained and removed in each case.

15. The method according to claim 12, wherein the draining comprises interaction between a shutoff valve of the block storage arrangements and an outlet valve of the block storage element.
